(19) United States
(12) Patent Application Publication
(10) Pub. No.: US 2014/0223481 A1
(43) Pub. Date: Aug. 7, 2014

(54) SYSTEMS AND METHODS FOR UPDATING A SEARCH REQUEST

(71) Applicant: UNITED VIDEO PROPERTIES, INC., Santa Clara, CA (US)

(72) Inventor: Andrew Fundament, Arlington Hts., IL (US)

(73) Assignee: UNITED VIDEO PROPERTIES, INC., Santa Clara, CA (US)

(21) Appl. No.: 13/762,136

(22) Filed: Feb. 7, 2013

(51) Int. Cl. H04N 21/482

(52) U.S. Cl. CPC H04N 21/4828
USPC 725/40

(57) ABSTRACT

Systems and methods for updating the search requests in interactive grid displays are presented. User equipment may receive a request to search a database of media asset information to find a media asset related to a received search string and the time window of the displayed interactive grid. After the search is complete, the search results may be presented to a user on the display. The user equipment may then receive a request to update the time window of the interactive grid display. In response to the update, the user equipment will search the database of media asset information for media assets related to the search string and the updated time window. The new search results may then be presented to the user. In some embodiments, the search results may be based on the search string and the displayed set of media asset sources on the interactive grid display.

### BACKGROUND

Current media systems allow users to search for specific media assets scheduled to be transmitted during a user specified time window. Typically, the user must enter a separate display to enter in the search request information, such as the media asset title and time window to search within. The user may then be presented with a list of search results which satisfy the request information.

However, if the user desires to change the time window of the search request, typically the user has to enter a separate display to re-enter the search request information. The step of re-entering the search information to simply update the search time window is a time consuming and tedious process for the user.

### SUMMARY

These and other objects are accomplished in accordance with the principles of the present invention by providing enhanced user equipment configured to provide more efficient navigation on interactive grid displays. In one embodiment, the user equipment generates a display of an interactive grid displaying descriptions of media assets at their corresponding time of transmission. The interactive grid may present the descriptions during a specific time window. A request to search the interactive grid during the specific time window for a media asset with a search string is received, and the search results are presented on the display. A request to change the time window of the interactive grid may then be received. In response to receiving the change in time window request, the interactive grid display will update to display descriptions of media assets that are scheduled to be transmitted during the new time window. Also, the displayed search results will be updated to correspond to media assets scheduled to be transmitted during the new time window.

In some embodiments, suggested media assets are generated on the display. The suggested media assets may be associated with the searched media asset descriptions associated with the input search string and the time window of the interactive grid. For example, if a request to search the interactive grid display for “sharks” is received, then media assets related to nature, animals, or documentaries may be suggested to the user.

In some embodiments, a second display may present search results based on media assets scheduled to be transmitted at a different time window from the time window of the interactive grid. The searched media assets may partially match the search string based on the received request and the interactive grid.

In some embodiments, a second display may present search results based on media assets scheduled to be transmitted at a different and non-overlapping time window from the time window of the interactive grid. The searched media assets may partially match the search string based on the received request and the interactive grid.

In some embodiments, search results for media assets that are also on the display of the interactive grid are visually distinguished on the interactive grid from media assets not contained in the search results. For example, if a search result is the media asset “American Idol,” and the same media asset is also present in the interactive grid, then the “American Idol” cell in the grid may be highlighted to differentiate it from the other media assets.

In some embodiments, the display of interactive grid is automatically navigated to present the search results for media assets scheduled for transmission during the time window of the interactive grid. For example, in response to a search request, the interactive grid will automatically navigate to the time and channel of the first search result.

In some embodiments, a plurality of user selectable characters for user input is generated to allow the user to generate a search string to search the interactive grid.

In some embodiments, the search results may be based on additional data. For example, the display of the search results may use a user's media asset viewing history to modify the search results.

In some embodiments, search results may be based on additional data, where the additional data may be one of search data, previous viewing data, or data associated with other users.

In some embodiments, the request to change the time window of the interactive grid may be received from a touch sensitive device. For example, a second device with touch sensitive features may receive a swipe to change the time window of the interactive grid.

### BRIEF DESCRIPTION OF THE DRAWINGS

The above and other features of the present invention, its nature and various advantages will be more apparent upon consideration of the following detailed description, taken in conjunction with the accompanying drawings, and in which:

FIG. 1 is a diagram of an interactive grid display in accordance with some embodiments of the disclosure.

FIG. 2 is a diagram of an interactive media system in accordance with some embodiments of the disclosure.

FIG. 3 is a block diagram of an illustrative user equipment device in accordance with some embodiments of the disclosure.

FIG. 4 is a block diagram of an illustrative media system in accordance with some embodiments of the disclosure.

FIG. 5A is a diagram of an interactive grid display after a search string request has been entered, in accordance with some embodiments of the disclosure.

FIG. 5B is a diagram of an interactive grid display where the media asset sources and time information are displayed on the horizontal and vertical axis, respectively in accordance with some embodiments of the disclosure.

FIG. 6 is a diagram of an interactive grid display after a search result is selected, in accordance with some embodiments of the disclosure.

FIG. 7 is a diagram of an interactive grid display after the grid is navigated to a second time window, in accordance with some embodiments of the disclosure.

FIG. 8 is a diagram of a notification display that is generated in the event that the search for media assets does not find a match during a particular time window, in accordance with some embodiments of the disclosure.

FIG. 9 is the flow diagram describing the process to update search results based on a second time window, in accordance with some embodiments of the disclosure.

FIG. 10 is the flow diagram describing the process to update search results based on a second set of media asset sources, in accordance with some embodiments of the disclosure.

### DETAILED DESCRIPTION OF EMBODIMENTS

Since a search request may imply the user does not know when a specific media asset may be scheduled to be transmitted, updating the time window of a search request is important to allow the user to quickly find the correct media asset. Furthermore, multiple updates to the search request time window may be a common occurrence for users. Thus, minimizing the time required to update the search request time window is an important feature.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

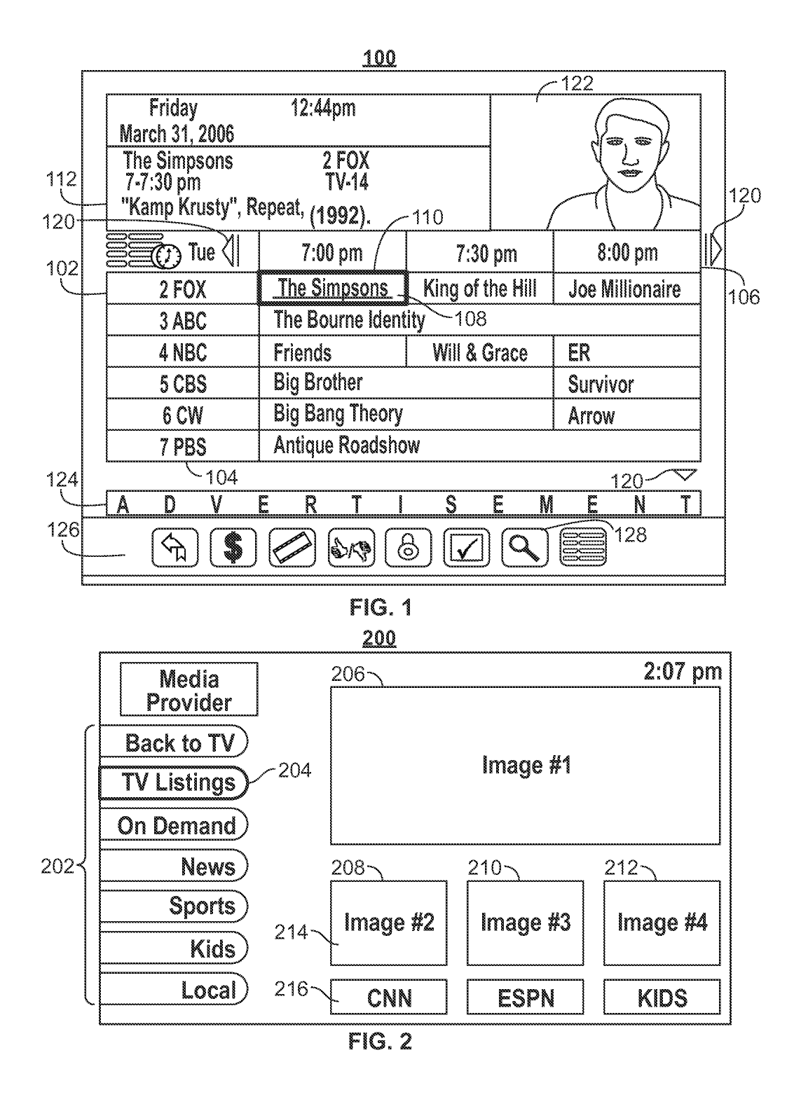

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP).

Grid 102 may provide media guidance data for non-linear programming including on-demand listings, recorded content listings, and Internet content listings. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to, or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options 128, VOD options, parental control options, Internet options, cloud-based options, device synchronization options, second screen device options, options to access various types of media guidance data displays, options to subscribe to a premium service, options to edit a user's profile, options to access a browse overlay, or other options.

Search option 128 may allow the user to search grid 102 for a specific media asset. For example, the user may select option 128 which may display a screen to allow the user to input a search request. Search option 128 may also allow the user to search for a media asset not displayed in grid 102. For example, media assets may be scheduled to be transmitted outside the time window of grid 102. Search option 128 may allow the user to search for media assets scheduled to be transmitted outside of the time window of grid 102.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200, the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

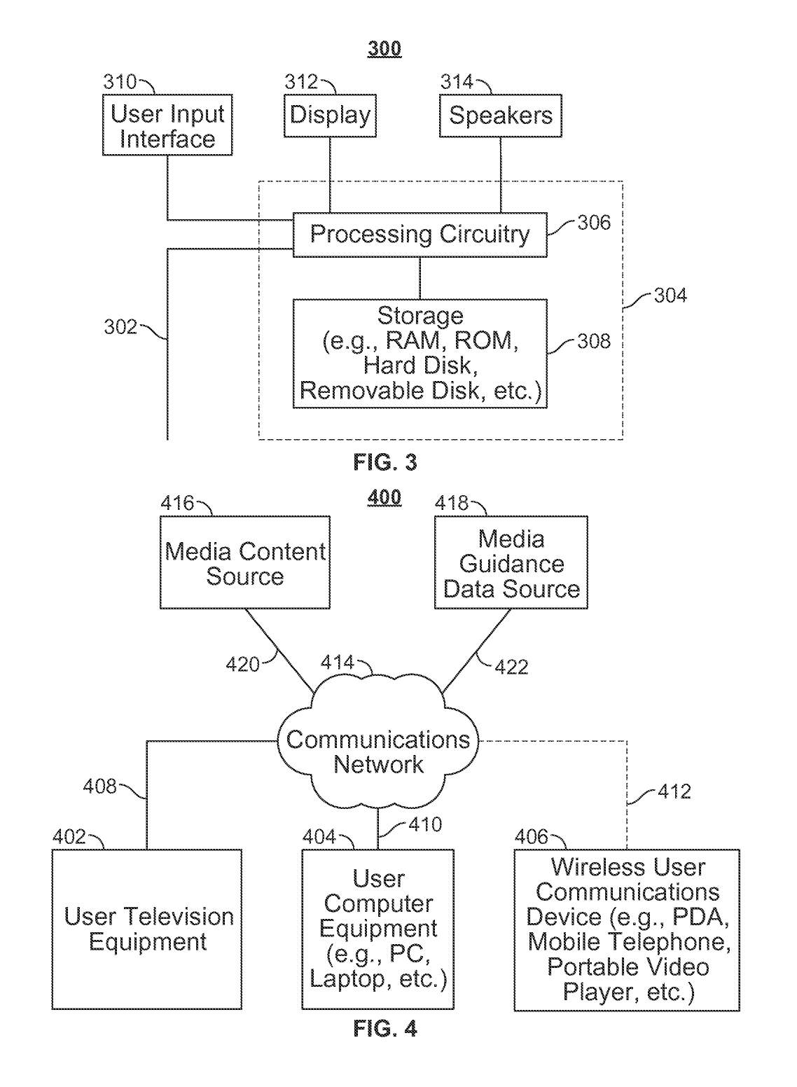

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiples of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Eulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same type. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

Control circuitry 304 may provide a number of algorithms to search a collection of media assets. For example, a text matching search algorithm may be used to search a collection of media assets for a specific media asset. A user may select option 128 to initiate a search request. The user may then enter a text string describing a media asset (e.g., episode title, show title, actors, directors, description). The text string may be entered with user input interface 310. Control circuitry 304 may then compare the user-entered text string with information related media assets scheduled to be transmitted in the current time window being displayed. The information related to media assets may be stored in storage 308. For example, the information related to media assets displayed in grid 102 may have been retrieved from media content source 416 and stored in storage 308. The information may also be retrieved from media content 416 or media guidance data source 418. For example, control circuitry 304 may retrieve information related to media assets during a specific time window and compare the retrieved information with the user entered text string. If the user inputted text string is contained in the information of the media assets, then the matched media assets are presented to the user. A number of search algorithms may be used to find a match to the user inputted text string within the information related to the media assets (e.g., binary search, sorting algorithms, hash tables).

Control circuitry 304 may search information related to media assets for partial matches to a user inputted text string. For example, if the user input string is “Big,” then control circuitry 304 may search the information related to the media assets and return the result “Big Bang Theory.” Although the user only entered the word “Big,” control circuitry 304 still found the search result of “Big Bang Theory” since it contains the word “Big.” Thus exact, full matches to the information related to media assets are not necessary.

Control circuitry 304 may also suggest search results based on a user input text string. For example, if the user enters the string “Big Bang Theory,” control circuitry 304 may find the search result of the television show “Big Bang Theory,” but it may also determine the phrase “Big Bang Theory” to be related to science and thus present a science documentary entitled “The Universe.” The determination of suggested results may be performed by control circuitry 304 accessing databases via the Internet. For example, control circuitry 304 may search the Internet for the phrase “Big Bang Theory” and use the results from a standard Internet search website (e.g., Google, Yahoo, Bing) to search for media assets related to the Internet search results. The Internet search results may contain a link related to the television show “Big Bang Theory” and a link related to a Wikipedia page entitled “Big Bang Theory,” which describes the science theory. Text from the Internet search result links would then be used to search information related to media assets to present suggested results to the user. A number of other algorithms may be used to suggest search results (e.g., crowd sourced based results, machine learning based results).

In some embodiments, a search algorithm may weight certain search results more than others. In some cases, a large amount of search results may be possible, and thus a method to prioritize which search results to present to the user may be needed. In some embodiments, a user's viewing history may be used to prioritize which results are displayed to the user. For example, if the letter “a” is the user inputted text string, then a large number of matches may be presented. To determine which media assets should be chosen to be displayed to the user, the user's previous viewing history may be used to weight certain media assets more than others. So if the viewer watches the television show “American Idol” frequently, then “American Idol” would be prioritized to be displayed over the other results of the search. A user's search history may be tracked with control circuitry 304. In some embodiments, television rating information may be used to weigh certain media assets over others. For example, if the letter “a” is the user inputted text string, and the television show “Ally McBeal” has the highest rating, then the media asset “Ally McBeal” may be prioritized over other search results. The media asset rating information may be stored in storage 308 or retrieved from media content source 416 or media guidance data source 418.

In some embodiments, search results may be based on search results of other users. For example, if a user enters the search string “Big” several possible search results may be possible to present to the user, such as “Big Bang Theory” or “Big Daddy”. Control circuitry 304 may communicate through communication network 414 to other user's media guidance data to determine that most users who search for the word “big” select the movie “Big Daddy”. Thus the search results may prioritize “Big Daddy” over other search results, such as “Big Bang Theory”. A cloud-based computing service may be used to search for other user's search results.

In some embodiments, the search results may be based on sponsored media assets. For example, search results may be presented to prioritize sponsored media assets by displaying the sponsored media assets ahead of non-sponsored media assets. Control circuitry 304 may determine a media asset to be a sponsored media asset by retrieving a list of sponsored media assets from media content source 416.

To enter a search string, a user may use a number of methods to input the string. A user may use the user input interface 310 as described above. In some embodiments, an on-screen keyboard may be presented to a user to allow the user to use user input interface 310 to enter a search string. For example, the on screen keyboard may display all of the letters of the alphabet and the user input interface 310 may allow the user to move a cursor to select each letter to type out a string. The same on-screen keyboard may also present the search results on the same screen or a different screen.

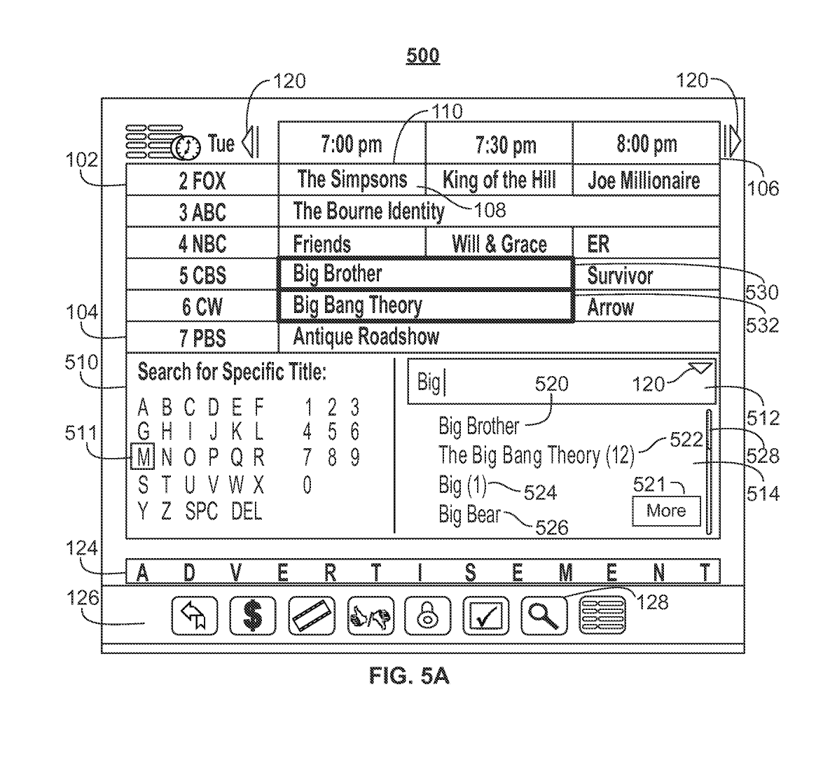

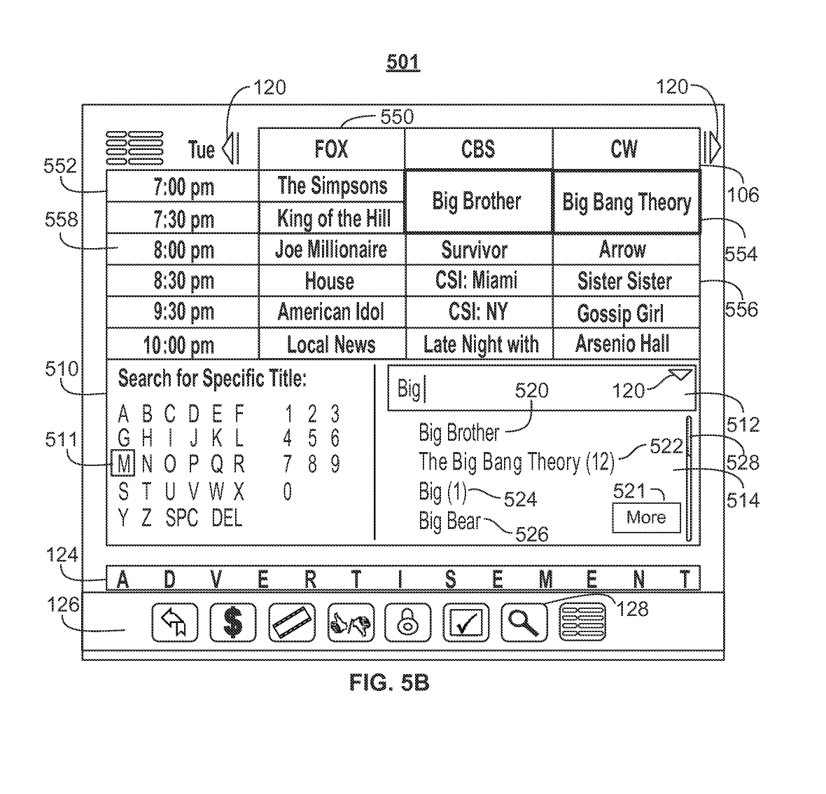

FIG. 5A presents the illustrative grid program listings display which contains an on-screen keyboard 510, grid 102, and the search results 514. A user may arrive to the display in FIG. 5A after selecting search option 128. The grid 102 displays the media assets scheduled to be transmitted during a certain time window, as described in FIG. 1. On-screen keyboard 510 may be used to allow the user to input a search string. Cursor 511 may be repositioned with user input interface 310 to select the letters or numbers presented. The resulting search string from the on-screen keyboard 510 is presented in text box 512. Search results 514 may be presented and updated while the user inputs each letter. For example, different search results may be presented as the user inputs each of the letters to spell out the string “Big”. Search results window 514 may contain the matching search results 520, 522, 524, and 526. Next to search results 522 and 524 is a number in parenthesis which may represent the number of matches found. The more search results button 521 may allow a user to search for additional search results. Scroll bar 528 may be used to scroll the search results window 514 to display more search results. The scroll bar may scroll by using the user input interface 310. The search results 514 are based on the time window shown in grid 102. For example, only media assets scheduled to be transmitted during the time window of grid 102 (7:00 pm-8:30 pm) on any media asset source will be searched. Search results present in grid 102 may be visually distinguished from media assets not present in the search results, as in the bolded outline of 530 and 532.

In some embodiments, the search results may also be based on the time window in grid 102 and the media asset sources displayed in grid 102. For example, processing circuitry 304 may search only the media assets during the time window present in the displayed grid 102. Thus only media asset sources channels 1 through 7 during the time window 7:00 pm to 8:30 pm are searched. In some embodiments, the search results may be based on a time window not presented by grid 102. For example, search results may contain media assets scheduled to be transmitted before or after the time window in grid 102.

In some embodiments, the search results may be visually distinguished on grid 102. For example, search results displayed on grid 102 may contain visual indicators, e.g., icons, graphic animations, font colors, background colors, or background graphics. In some embodiments, media assets not related to the search results are not displayed. For example, media assets not contained in the search results would be removed from the display of grid 102.

In some embodiments, the display grid may automatically scroll to a search result. For example, the present position of grid 102 may not contain a media asset listed in search result 514. If this is the case, then grid 102 may automatically navigate to the time window and media asset source range that contains a display of the matched media asset search result. Therefore, the media asset sources shown on grid 102 prior to receiving the search request are different from the media asset sources shown on grid 102 after receiving the search request. In some embodiments, the user may jump the grid display from one search result to the next. For example, in response to receiving a search request, the search results may be presented in search result window 514. A command may be received from user input interface 310 to scroll the arrow icon 610 to the media asset “Big” 524. In response to scrolling the icon, control circuitry 304 may automatically navigate grid 102 to display the media asset “Big” in grid 102.

In some embodiments, search result window 514 may only display a fixed number of search results. For example, the search result window 514 may only present 20 results. In some embodiments, the user may change the number of displayed search results. For example, the user may change the number of displayed search results to 50. The number of displayed search results may be stored in control circuitry 304. In some embodiments, search result window 514 may display a variable number of search results. For example, the number of displayed search results may depend on the number of search results. If there are under 10 results, then all 10 results may be displayed. But if there are more than 10 results, then only 50% of the search results are displayed.

In some embodiments, the second screen device may be used to display the search results. The second screen device, as described above, may be used to display the search results and allow the user to scroll through the search results. For example, the user may enter the search string to be displayed on the second screen device. The second screen device may display the search results.

In some embodiments, the illustrative grid program listings display may display the grid of media assets such that the media asset sources are displayed on the horizontal axis, and the time information is displayed on the vertical axis. The display of the media assets will be displayed in the corresponding section of the grid, based on the media asset source and scheduled transmission time.

FIG. 5B shows the illustrative grid program guide listings displaying the grid where the media asset source information is displayed on the horizontal axis and the time information is displayed on the vertical axis. A user may arrive to the display in FIG. 5B after selecting search option 128. The time information 558 is displayed on the vertical axis, and the media asset source information 550 is displayed on the horizontal axis. Grid 552 displays the media asset information in the corresponding location in the grid based on the source of the media asset and the scheduled transmission time. The highlighted media assets 554 are visually distinguished because they match, at least partially, the search string in text box 512. The media asset information that does not partially match the search string in text box 512 are not visually distinguished. Navigation icons 120 may be used to change the display of the grid to a new time window, or to a new set of media asset sources. The search features in FIG. 5A may be used as similarly described above in FIG. 5B.

In some embodiments, the user may select a media asset in the display of the search results to navigate the display grid to the selected media asset. If there are multiple results for the selected media asset, then the closest media asset in time, or media asset source, is selected.

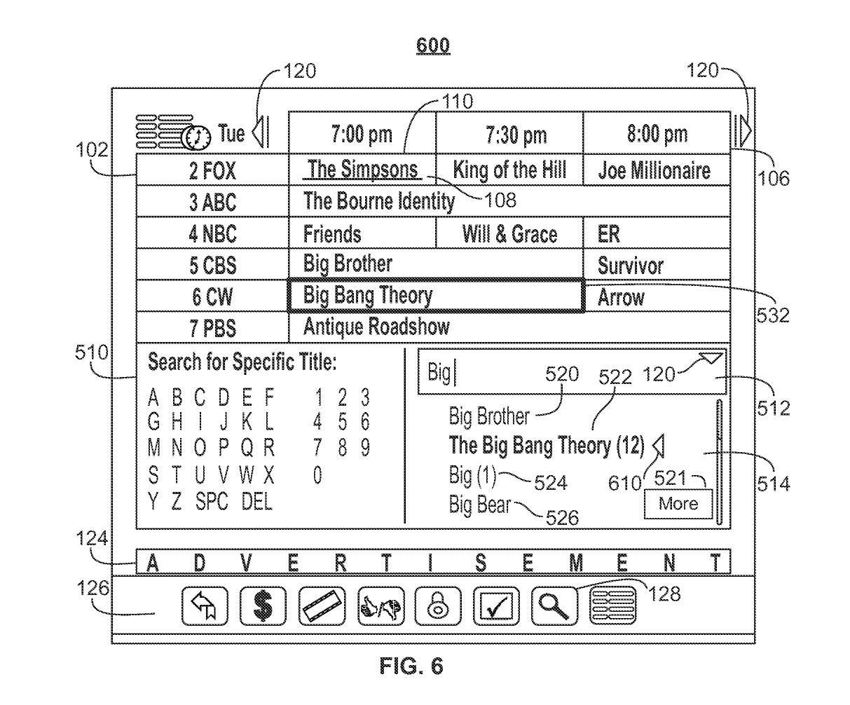

FIG. 6 shows the illustrative grid program listings displaying the user selecting a media asset from the search result list and displaying the selected media asset in grid 102. Arrow icon 610 indicates which of the media assets in the search results is currently selected. The user may use user input interface 310 to navigate arrow icon 610 up and down the search results list. Visual indicator 532 visually indicates where the selected media asset is located in grid 102. When the user navigates arrow icon 610 to a second media asset in the search result list, grid 102 navigates to display the second media asset.

In some embodiments, the list of search results scrolls while a visually distinguishing feature remains static while the user scrolls the search result list. For example, arrow icon 610 may remain static, while the list of search results scrolls up and down.

In some embodiments, the selected media asset in the list of search results is visually distinguished. For example, the selected media asset may be a different font color, font size, font style, or contain a graphical icon. As the user scrolls the list of search results, an auditory signal may be used to indicate the list is scrolling. For example, as the list is scrolled an audio signal is outputted from control circuitry 304 to speakers 314.

In some embodiments, the user may alter the time window of the display grid during a search to a new time window, which alters the search results to display matching media assets scheduled to be transmitted during the new time window. For example, control circuitry 304 may display grid 102 at a certain time window. The time window value may be stored in storage 308. A search request containing a search string may be received by control circuitry 304, where a search string may be stored in storage 308. The media assets scheduled to be transmitted during the time window of grid 102 are searched in the database. The database may be locally stored in storage 308 or may be retrieved from media content source 416 or media guidance data source 418. Control circuitry 308 may display the search results in search results list 514. A request to update the time window of grid 102 may be received to change the time window to a new time window. In response to the request to update the time window, control circuitry 304 searches the database again with the search string for media assets scheduled to be transmitted during the new time window. The new search results may be displayed in search results list 514.

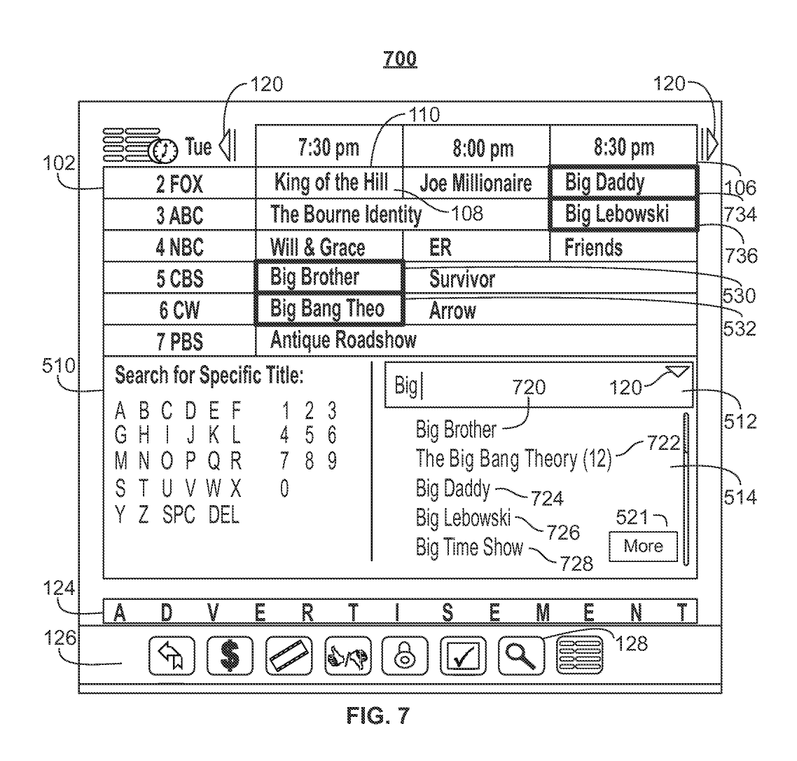

FIG. 7 shows the illustrative grid program listings display after the user navigates the grid 102 to a new time window (7:30 pm-9:00 pm) while the search results are still displayed. Since the time window of the grid 102 has been altered, the search results list 514 automatically updates the search result to find matches within the new time window, thus media asset titles 720, 722, 724, 726, and 728 are listed. For example, at 8:30 pm new media assets entitled “Big Daddy” 734 and “The Big Lebowski” 736 are present in grid 102. Since both new media assets match the search string “Big”, search results list 514 is automatically updated to contain these two new media asset titles. Also, on the interactive grid, the two new listings are visually distinguished from the non-matching media asset titles, as are the previously displayed matches 530 and 532. Search results list 514 may contain other new matches that are not in the present display of grid 102, such as media asset 728, and are transmitted from media asset sources other than the displayed media asset sources on grid 102 (channels 2 through 7). As described above, the user may use user input interface 310 to select a media asset title in search result list 514.

In some embodiments, the search results list 514 may only contain matches related to media assets displayed during the present time window and media asset source range of grid 102, as described above. Thus when the user navigates grid 102 to a new time window, media search results list 514 may be updated by control circuitry 310 to display matches within the new time window, as described above. If the user navigates grid 102 to a new range of media asset sources, then search results list 514 may be updated to display matches within the new range of media asset sources. For example, in display 102, only media asset source channels 2-7 are displayed. Thus, search results list 514 may only display matches corresponding to media assets scheduled to be transmitted from media asset sources channels 2-7. If the user navigates grid 102 such that the new range of media asset sources is channels 12-17, then search results list 514 will be updated to present matches for media assets scheduled to be transmitted from media asset sources channels 12-17. The time window of the search remains the same, before and after the range of media asset sources is changed.

In some embodiments, grid 102 may be navigated to a new time window by using the second screen device. For example, a grid may be displayed on the second screen device during a first time window. A user may navigate the grid to a second time window. The signal to navigate the grid to a second time window may come from a number of methods (e.g., touch screen input). Similarly as described above, when the grid is updated to a second time window, search results list 514 may be updated to present new search results related to media assets scheduled to be transmitted at the new time window. As described above, search results list 514 may also be displayed on the second screen display.

In some embodiments the signal to navigate grid 102 to a new time window may come from a gesture input, received by a 3D camera. For example, user input interface 310 may be a 3D camera, receiving 3D gestures from a user. When the gesture to “swipe left” is received, the 3D camera transmits the signal to control circuitry 308 to navigate grid 102 to the second time window.

In some embodiments the signal to navigate grid 102 to a new time window may come from a voice command, received by audio detector device. For example, user input interface 310 may be a microphone, receiving audio signals from a user. When the audio signal “scan forward” is received, the microphone transmits the signal to control circuitry 308 to navigate grid 102 to the second time window.

In some cases, control circuitry 308 will find no search results to the user inputted search string during the time window of grid 102. When this is the case, control circuitry 308 will search the information related to media assets outside of the current time window of grid 102. If a result is found, a notification will be displayed informing the user of the matches outside of the time window of grid 102. In some embodiments, the user may press the more search results button 521 to search for media assets scheduled to be transmitted either before or after the time window of grid 102. For example, even after a successful search finds a number of search results, the user may still select the more search results button 521 to search for media assets outside of the time window of grid 102.

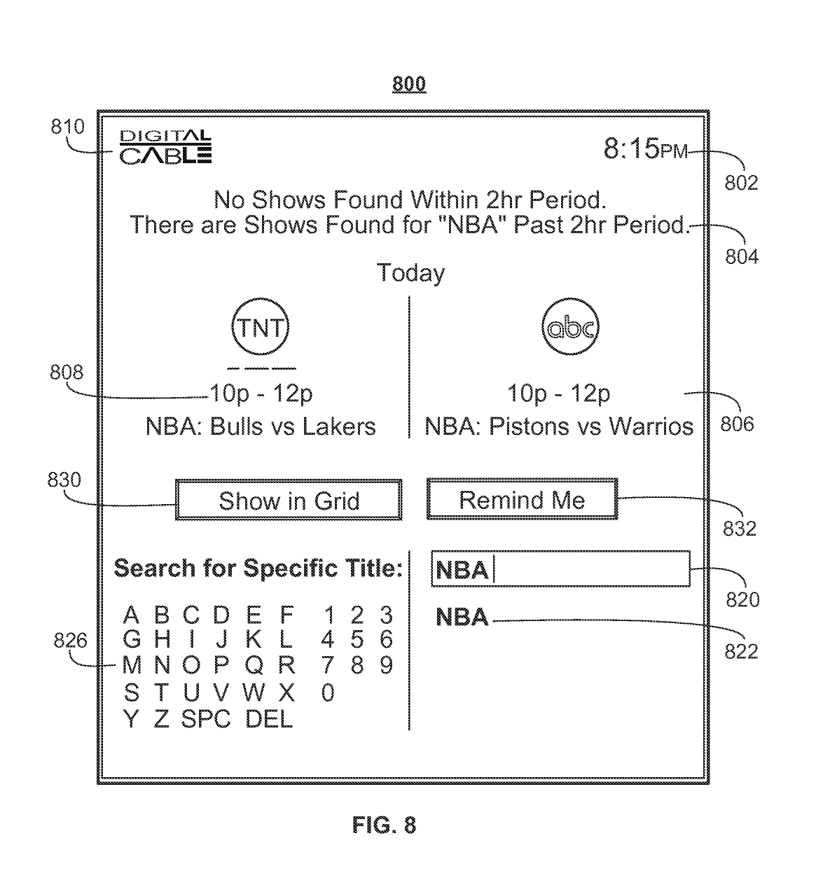

FIG. 8 shows notification display 800 to the user stating that no search results were found during the time window of grid 102, and presents other media assets scheduled to be transmitted outside of the time window of grid 102 that match the search text string. Time indicator 802 displays the current time. Media service provider is indicated in icon 810. Notification description 804 indicates to the user that no search results were found in the current time window of grid 102. Media asset descriptions 806 and 808 describe the search results for media assets outside of the time window of grid 102. Search text bar 820 displays the current search text string entered by the user. Search result 822 displays the search results of media assets scheduled to be transmitted outside of the time window of grid 102, as similarly described in search results list 514. On-screen keyboard 826 allows the user to select letters and numbers to input into search text bar 820, as described above. Button 830 allows the user to switch the display back to the illustrative grid program listings display 100 and automatically navigate grid 102 to display the search result. Button 832 allows the user to set a reminder by using control circuitry 308. When the time nears the scheduled transmission time of the selected media asset, media asset control circuitry 308 will display a reminder notification, notifying the user that the media asset will be transmitted soon. The time for the reminder may be a user selectable time, a fixed time, or a predetermined time period.

If the user changes the input search string in search text bar 820, such that search results of media asset are scheduled to be transmitted during the time window of grid 102 are found, then the notification display 800 will close and listings display 600 will be displayed. For example, if user changes the search text string in search text bar 820, then the search result 822 may be automatically updated to present new search results corresponding to the changed search text string. If the new search results disclose media assets that are scheduled to be transmitted during the time window of grid 102, then notification display 800 will close and listings display 600 will be displayed, showing the new search results. In some embodiments, the search result 822 will be updated when the user selects the search button. For example, after changing the search text string in search text bar 820, nothing in notification display 800 will change. However, if the user then selects a search button, then processing circuitry 308 will search for new matches for the new search text string. If valid time window matches are found, then notification display 800 will close and listings display 600 will be displayed, as described above.

In some embodiments, notification display 800 may display a grid of search results containing media assets scheduled to be transmitted out of the time window of grid 102. For example, a large number of search results may be generated and displayed in a grid format, as similarly shown in grid 102. Media asset sources and a time window may be used to define the axes of the grid. In some embodiments, a list of search results may be displayed, wherein the search results contain media assets schedule to be transmitted out of the time window of grid 102. For example, a list of search results consisting of media assets may be displayed, along with their corresponding media asset sources. Each element of the list may be selectable by the user. If a media asset displayed in the list is selected, the user may be presented with a display containing options (e.g., remind me function, record, block, or more information). Various other methods may be used to display the numerous search results including, but not limited to, an array of results, a scrollable window, an iterating display of icons, or a calendar display.

In some embodiments, notification display 800 may be displayed in the form of a pop-up window. For example, if the search function performed by control circuitry 308 cannot find any search results while displaying illustrative grid program listings display 600, notification display 800 may be displayed on top of listings display 600, such that listing display 600 is still visible behind notification display 800.

In some embodiments, notification display 800 may be displayed on the second screen device. For example, if the search function performed by control circuitry 308 cannot find any search results while displaying illustrative grid program listings display 600, then notification display 800 may be displayed on the second screen device. In some embodiments, the user may interact with notification display 800 via a touch sensitive device. For example, a capacitive touch sensitive device may be used to allow the user to use his/her fingers to select button 830.

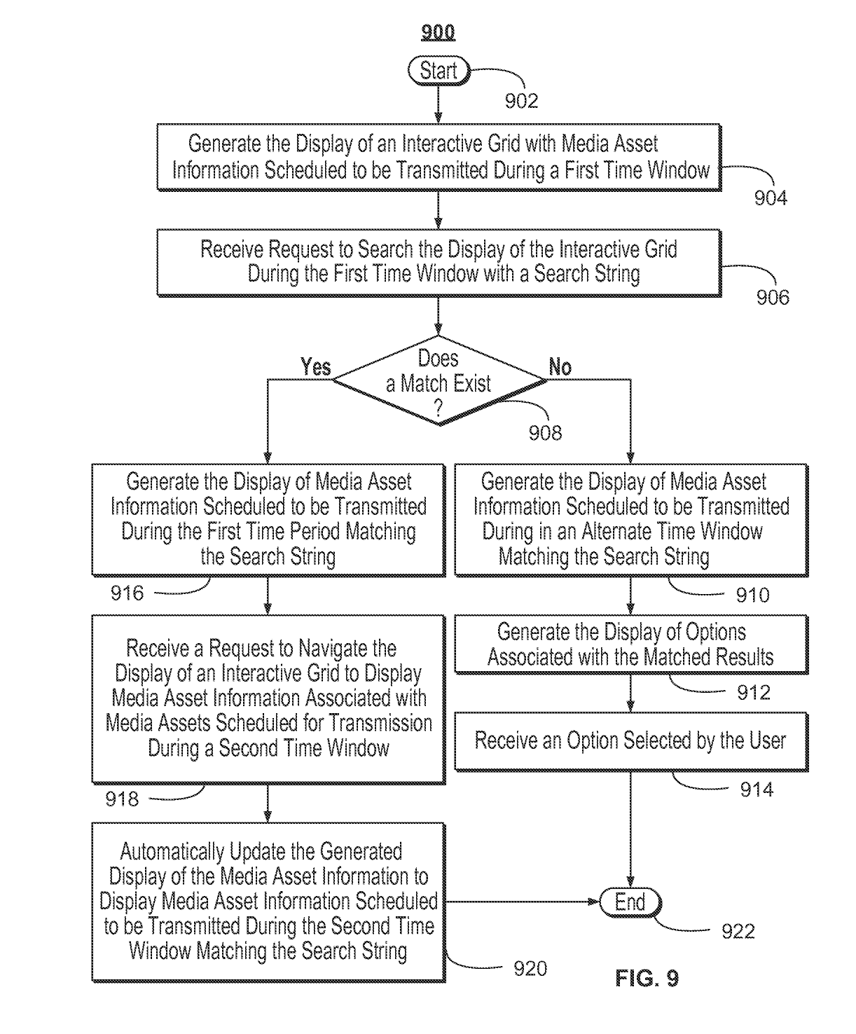

FIG. 9 shows a flow chart illustrating the steps of updating search results when the display grid of media asset information is navigated to a new time window. The process begins at step 902, which may occur when the user selects to open the grid display. For example, a request to open the grid display may be received from user input interface 310.

At step 904 the display of an interactive grid with media asset information scheduled to be transmitted during a first time window is displayed, as similarly described in FIG. 1. For example, the illustrative grid program listings display 100 may be displayed after a user selects a “guide” button on a remote control.

At step 906 a request to search the display of the interactive grid is received. The search request searches the interactive grid display during the first time window. The search may be a partial search and may use a number of search algorithms as described above. For example, the search request may be received by a user selecting the search option 128 in FIG. 1. In some embodiments, the search request signal may be received from a user input interface 310. For example, a remote control may have a “search” button, from which a user may select to send the search request to control circuitry 304.

At step 908, if a search result exists such that the resulting media asset is scheduled to be transmitted during the first time window, then the process continues to step 916. For example, control circuitry 304 may search the database for matching media assets to the search request. If more than zero search results are found, then the process continues to step 916. If zero search results are found, then the process continues to step 910.

At step 916 the search results of the media assets scheduled to be transmitted at the first time window are displayed. For example, after control circuitry 304 finds a non-zero number of search results, the search results may be displayed in search results list 514 in FIG. 5A.

At step 918 a request to navigate the display of the interactive grid to a second time window is received. For example, if the user selects navigational icons 120 to change the time window of grid 102, then the request to change the time window is received by control circuitry 304. In some embodiments, the request to change the time window of grid 102 may be received from user input interface 310. For example, a remote control may have arrow buttons allowing a user to navigate the time window of grid 102.

At step 920, the display of the search results is automatically updated to present search results of media assets scheduled to be transmitted during the second time window. For example, control circuitry 304 may search the media asset information for media assets scheduled to be transmitted during the updated time window, as shown in FIG. 7. The search results may be displayed, as shown in search results 720, 722, 724, 726, and 728.

If at step 908 no search results are found during the first time window, the process continues to step 910. At step 910, the media asset information related to media asset schedule to be transmitted outside of the first time window that match the search string are displayed, as described above in notification display 800.

At step 912, options associated with the matched results are displayed. Options may include, but are not limited to, show in grid, remind, or record. For example, options 830 and 832 in FIG. 8 may be selected by the user to either show the media asset in the grid or set a reminder in control circuitry 304 to alert the user in the future of the selected media asset.

At step 914 a selected option is received. For example, the user may selection option “Show in Grid” 830 in FIG. 8. At step 922 the process concludes.

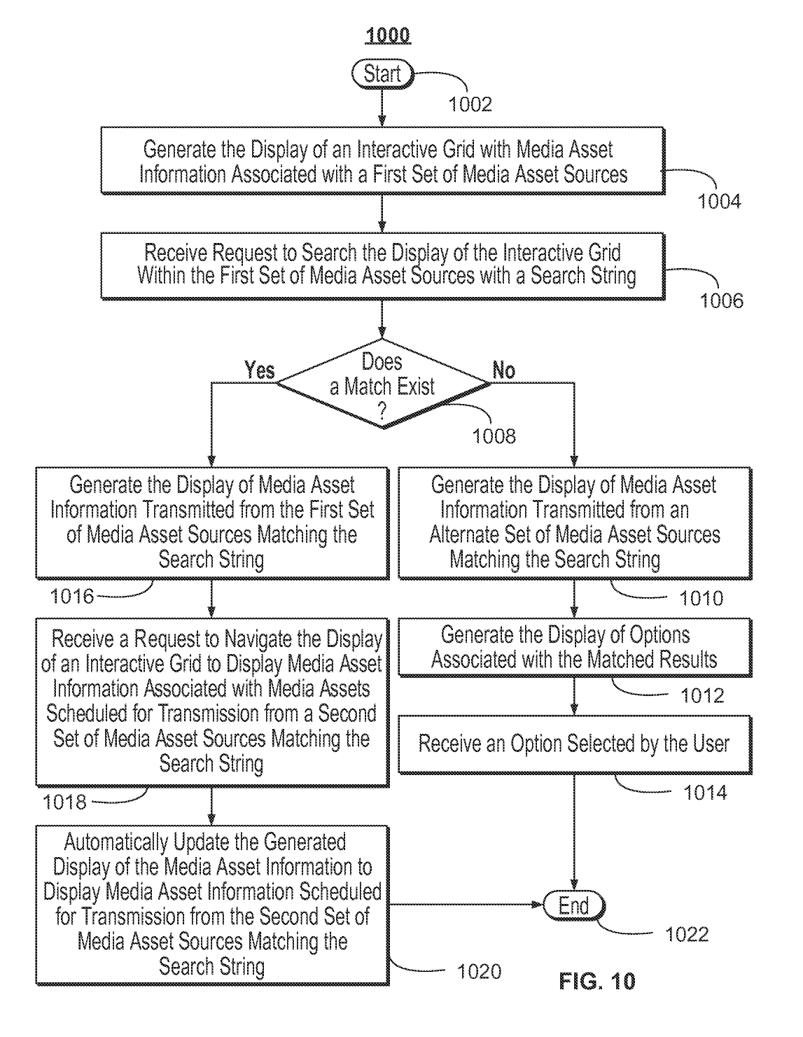

FIG. 10 shows a flow chart illustrating the steps of updating the search results when a user navigates the display grid of media asset information to a second set of media asset sources. The process begins at step 1002, and may begin when a request to display the display grid is received. For example, a request to open the grid display may be received from user input interface 310.

At step 1004 the display of an interactive grid with media asset information associated with a first set of media asset sources is generated, as previously described above in FIG. 1. For example the illustrative grid program listings display 100 may be displayed after a user selects a “guide” button on a remote control.

At step 1006 a request to search the display of the interactive grid within the first set of media asset sources with a search string is received. For example, the search request may be received by a user selecting the search option 128 in FIG. 1. In some embodiments, the search request signal may be received from a user input interface 310. For example, a remote control may have a “search” button, from which a user may select to send the search request to control circuitry 304.

At step 1008, if the search results are found the process continues to step 1016. For example, control circuitry 304 may search the database for matching media assets to the search request. If more than zero searches results are found, then the process continues to step 1016. If zero search results are found, then the process continues to step 1010.

At step 1016 the display of media asset information transmitted from the first set of media asset sources matching the search string is generated. For example, after control circuitry 304 finds a non-zero number of search results, the search results may be displayed in search results list 514 in FIG. 5A.

At step 1018, a request to navigate the display of an interactive grid to display media asset information associated with media assets scheduled for transmission from a second set of media asset sources matching the search string is received. For example, if the user selects navigational icons 120 to change the set of media asset sources of grid 102, then the request to change the set of media asset sources is received by control circuitry 304. In some embodiments, the request to change the set of media asset sources of grid 102 may be received from user input interface 310. For example, a remote control may have arrow buttons allowing a user to navigate the set of media asset sources of grid 102.

At step 1020, the display of the media asset information to display media asset information scheduled for transmission from the second set of media asset sources matching the search string is automatically updated. For example, control circuitry 304 may search the media asset information for media assets scheduled to be transmitted during the updated time window, as shown in FIG. 7. The search results may be displayed, as shown in search results 720, 722, 724, 726, and 728.

If at step 1008 it is determined that no matches exist within the first set of media asset sources, then the process continues to step 1010. At step 1010 the display of media asset information transmitted from an alternate set of media asset sources matching the search string is generated. For example, alternate sources such as on-demand video, recorded video, Internet video, or other media may be searched and displayed, as similarly described in FIG. 8.

At step 1012, the display of options associated with the matched results is displayed, as described above. A request of a selected option is received. Options may include, but are not limited to, show in grid, remind, or record. For example, options 830 and 832 in FIG. 8 may be selected by the user to either show the media asset in the grid or set a reminder in control circuitry 304 to alert the user in the future of the selected media asset. The process may conclude at step 1022.

It should be understood that the above steps of the flow diagrams of FIGS. 9 and 10 may be executed or performed in any order or sequence not limited to the order and sequence shown and described in the figures. Also, some of the above steps of the flow diagrams of FIGS. 9 and 10 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for updating search results generated for display in an interactive grid, the method comprising:
receiving a first request to search the interactive grid within a first time window for media asset information at least partially matching a search string;
generating for display the interactive grid comprising the media asset information associated with media assets scheduled for transmission during the first time window at least partially matching the search string based on the received request, wherein media asset source information is displayed on a horizontal axis of the grid and time information is displayed on a vertical axis of the grid;
receiving a second request to navigate the interactive grid to display media asset information associated with media assets scheduled for transmission during a second time window;
in response to the second request, searching for media assets scheduled for transmission during the second time window that partially match the search string; and
automatically updating the generated display of the media asset information at least partially matching the search string to reflect media asset information associated with the media assets identified by the search.

2. The method of claim 1, further comprising generating for display suggested media asset information associated with the media assets scheduled for transmission during the first time window at least partially matching the search string based on the received request and the interactive grid.

3. The method of claim 1, wherein the generated display is a first display, the method further comprising:
generating a second display of media asset information associated with media assets scheduled for transmission during a third time window at least partially matching the search string based on the received request and the interactive grid.

4. The method of claim 3, wherein the third time window does not overlap with the first time window.

5. The method of claim 1, further comprising visually distinguishing the media asset information associated with media assets scheduled for transmission during the first time window at least partially matching the search string based on the received request and the interactive grid.

6. The method of claim 1, further comprising automatically navigating the generated display of the interactive grid to show the media asset information associated with the media assets scheduled for transmission using the first time window at least partially matching the search string based on the received request and the interactive grid.

7. The method of claim 1, wherein the generated display further comprises additional data associated with the media assets scheduled for transmission during the first time window.

8. The method of claim 8, wherein the additional data comprises at least one of previous search data, previous viewing data, or data associated with other users.

9. The method of claim 1, wherein the generated display is a first display and the first request is received while a second display of the interactive grid is generated, wherein the second display includes media asset information for a first set of media asset source information.

10. The method of claim 9, wherein the first display includes media asset information for a second set of media asset source information different from the media asset information for the first set of media asset source information.

11. A system for updating search results generated for display in an interactive grid, the system comprising:
control circuitry configured to:
receive a first request to search the interactive grid within a first time window for media asset information at least partially matching a search string;
generate for display the interactive grid comprising the media asset information associated with media assets scheduled for transmission during the first time window at least partially matching the search string based on the received request, wherein media asset source information is displayed on a horizontal axis of the grid and time information is displayed on a vertical axis of the grid;
receive a second request to navigate the interactive grid to display media asset information associated with media assets scheduled for transmission during a second time window;
in response to the second request, search for media assets scheduled for transmission during the second time window that partially match the search string; and
automatically update the generated display of the media asset information at least partially matching the search string to reflect media asset information associated with the media assets identified by the search.

12. The system of claim 11 wherein the control circuitry is further configured to:
generate for display suggested media asset information associated with the media assets scheduled for transmission during the first time window at least partially matching the search string based on the received request and the interactive grid.

13. The system of claim 11 wherein the generated display is a first display and the control circuitry is further configured to:
generate a second display of media asset information associated with media assets scheduled for transmission during a third time window at least partially matching the search string based on the received request and the interactive grid.

14. The system of claim 13, wherein the third time window does not overlap with the first time window.

15. The system of claim 11 wherein the control circuitry is further configured to:
visually distinguish the media asset information associated with media assets scheduled for transmission during the first time window at least partially matching the search string based on the received request and the interactive grid.

16. The system of claim 11 wherein the control circuitry is further configured to:
automatically navigate the generated display of the interactive grid to show the media asset information associated with the media assets scheduled for transmission using the first time window at least partially matching the search string based on the received request and the interactive grid.

17. The system of claim 11, wherein the generated display further comprises additional data associated with media assets scheduled for transmission during the first time window.

18. The system of claim 18, wherein the additional data comprises at least one of previous search data, previous viewing data, or data associated with other users.

19. The system of claim 11, wherein the generated display is a first display and the first request is received while a second display of the interactive grid is generated, wherein the second display includes media asset information for a first set of media asset source information.

20. The system of claim 19, wherein the first display includes media asset information for a second set of media asset source information different from the media asset information for the first set of media asset source information.

21-30. (canceled)

31. A non-transitory machine-readable medium comprising instructions thereon for updating search results generated for display in an interactive grid, the instructions comprising:
instructions to receive a first request to search the interactive grid within a first time window for media asset information at least partially matching a search string;
instructions to generate for display the interactive grid comprising the media asset information associated with media assets scheduled for transmission during the first time window at least partially matching the search string based on the received request, wherein media asset source information is displayed on a horizontal axis of the grid and time information is displayed on a vertical axis of the grid;
instructions to receive a second request to navigate the interactive grid to display media asset information associated with media assets scheduled for transmission during a second time window;
instructions to search, in response to the second request, for media assets scheduled for transmission during the second time window that partially match the search string; and
instructions to automatically update the generated display of the media asset information at least partially matching the search string to reflect media asset information associated with the media assets identified by the search.

32. The non-transitory machine-readable medium of claim 31, further comprising instructions to:
generate for display suggested media asset information associated with the media assets scheduled for transmission during the first time window at least partially matching the search string based on the received request and the interactive grid.

33. The non-transitory machine-readable medium of claim 31, wherein the generated display is a first display, the non-transitory machine-readable medium further comprising instructions for:
generating a second display of media asset information associated with media assets scheduled for transmission during a third time window at least partially matching the search string based on the received request and the interactive grid.

34. The non-transitory machine-readable medium of claim 33, wherein the third time window does not overlap with the first time window.

35. The non-transitory machine-readable medium of claim 31, further comprising instructions to:
visually distinguish the media asset information associated with media assets scheduled for transmission during the first time window at least partially matching the search string based on the received request and the interactive grid.

36. The non-transitory machine-readable medium of claim 31, further comprising instructions to:
automatically navigate the generated display of the interactive grid to show the media asset information associated with the media assets scheduled for transmission using the first time window at least partially matching the search string based on the received request and the interactive grid.

37. The non-transitory machine-readable medium of claim 31, wherein the generated display further comprises additional data associated with the media assets scheduled for transmission during the first time window.

38. The non-transitory machine-readable medium of claim 37, wherein the additional data comprises at least one of previous search data, previous viewing data, or data associated with other users.

39. The non-transitory machine-readable medium of claim 31, wherein the generated display is a first display and the first request is received while a second display of the interactive grid is generated, wherein the second display includes media asset information for a first set of media asset source information.

40. The non-transitory machine-readable medium of claim 39, wherein the first display includes media asset information for a second set of media asset source information different from the media asset information for the first set of media asset source information.

41. The method of claim 1, wherein the interactive grid comprises a plurality of rows and a plurality of columns, and wherein each of the plurality of rows and each of the plurality of columns comprises at least one media asset scheduled for transmission during the first time window at least partially matching the search string.

42. The system of claim 11, wherein the interactive grid comprises a plurality of rows and a plurality of columns, and wherein each of the plurality of rows and each of the plurality of columns comprises at least one media asset scheduled for transmission during the first time window at least partially matching the search string.
